(19) United States
(12) Patent Application Publication
(10) Pub. No.: US 2025/0322731 A1
(43) Pub. Date: Oct. 16, 2025

(54) GAMING DEVICE WITH INTERRELATED FEATURE GAMES

(71) Applicant: Aristocrat Technologies Australia PTY Limited, North Ryde (AU)

(72) Inventors: Talles Vito, Warriewood (AU); Lucas Azevedo dos Santos, Freshwater (AU); Jason Meyer, Wyoming (AU)

(21) Appl. No.: 19/092,547

(22) Filed: Mar. 27, 2025

(30) Foreign Application Priority Data
Apr. 15, 2024 (AU) 2024202455

(51) Int. Cl. G07F 17/34; G07F 17/32

(52) U.S. Cl. CPC G07F 17/34; G07F 17/3211

(57) ABSTRACT

A gaming device comprises an electronic display, a random number generator, a processor, and a memory storing (i) symbol data defining a first set of reel strips, and trigger symbols including a plurality of first trigger symbols and at least one second trigger symbol, and (ii) instructions. When the instructions are executed by the processor, they cause the processor to control the display to display a plurality of columns of symbol positions for which symbols will be selected in at least a base game, select from the first set of reel strips, using the random number generator, symbols for each of the symbol positions, upon the selected symbols including at least a defined number of trigger symbols, award a first feature game, upon the at least a defined number of trigger symbols including the second trigger symbol, additionally award a second feature game, and conduct each awarded feature game.

### CROSS-REFERENCE TO RELATED APPLICATION

The present application claims priority to Australian Patent Application No. 2024202455, filed Apr. 15, 2024, and entitled, “Gaming Device with Interrelated Feature Games.”

### TECHNICAL FIELD

The present application relates to a gaming device, a method of operating a gaming device and a system with interrelated feature games.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. Upon initiation of play, the RNG randomly determines a game outcome and symbols are then selected which correspond to that outcome. Notably, some games may include an element of skill on the part of the player and are therefore not entirely random.

A problem for game designers is development of games which can provide variety in volatility (e.g., size and frequency of payouts). There is a need for new gaming machines to provide improved options for game designers to manipulate variety and volatility.

### SUMMARY

There is disclosed a gaming device, a method of operating a gaming device.

An example embodiment describes a gaming device comprising an electronic display, a random number generator, a processor, and a memory storing (i) symbol data defining a first set of reel strips, and trigger symbols including a plurality of first trigger symbols and at least one second trigger symbol, and (ii) instructions. When the instructions are executed by the processor, they cause the processor to control the display to display a plurality of columns of symbol positions for which symbols will be selected in at least a base game, select from the first set of reel strips, using the random number generator, symbols for each of the symbol positions, upon the selected symbols including at least a defined number of trigger symbols, award a first feature game, upon the at least a defined number of trigger symbols including the second trigger symbol, additionally award a second feature game, and conduct each awarded feature game.

Another example embodiment describes a method of operating a gaming device comprising an electronic display, a random number generator, and a memory storing symbol data defining a first set of reel strips and trigger symbols including a plurality of first trigger symbols and at least one second trigger symbol. The method comprises controlling the display to display a plurality of columns of symbol positions for which symbols will be selected in at least a base game, selecting from the first set of reel strips, using the random number generator, symbols for each of the symbol positions, upon the selected symbols including at least a defined number of trigger symbols, awarding a first feature game, upon the at least a defined number of trigger symbols including the second trigger symbol, additionally awarding a second feature game, and conduct each awarded feature game

Another example embodiment describes a system comprising at least one electronic display, a random number generator, one or more processors, and at least one memory storing (i) symbol data defining a first set of reel strips, and trigger symbols including a plurality of first trigger symbols and at least one second trigger symbol, and (ii) instructions. When the instructions are executed by the one or more processors, they cause the one or more processors to control the at least one display to display a plurality of columns of symbol positions for which symbols will be selected in at least a base game, select from the first set of reel strips, using the random number generator, symbols for each of the symbol positions, upon the selected symbols including at least a defined number of trigger symbols, award a first feature game, upon the at least a defined number of trigger symbols including the second trigger symbol, additionally award a second feature game, and conduct each awarded feature game.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIG. 6 is another flow chart of a method of operating a gaming device.

FIG. 7 is another flow chart of a method of operating a gaming device.

FIGS. 8 to 21 are example screen displays.

### DETAILED DESCRIPTION

There is disclosed a gaming device, a method of operating a gaming device and a system with interrelated feature games. In an example embodiment, the gaming device, the method and system provide first and second feature games that are interrelated by enabling the first and second feature games to be triggered from a single trigger event and providing two, independent opportunities to win a common prize when both the first and second feature games are conducted.

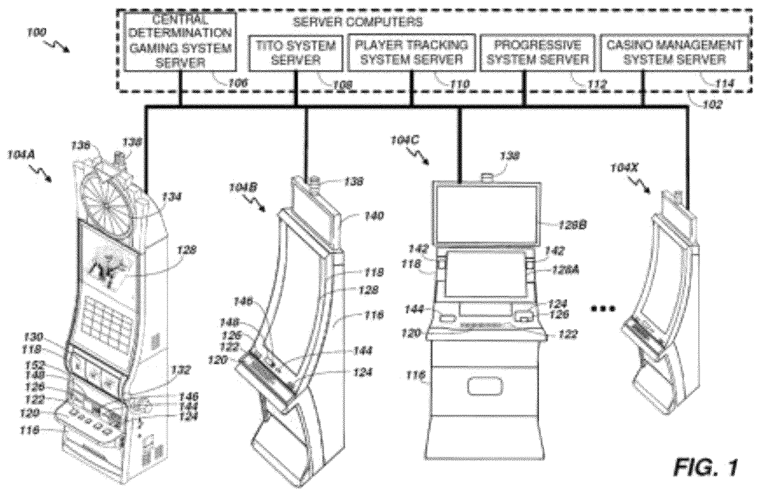

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

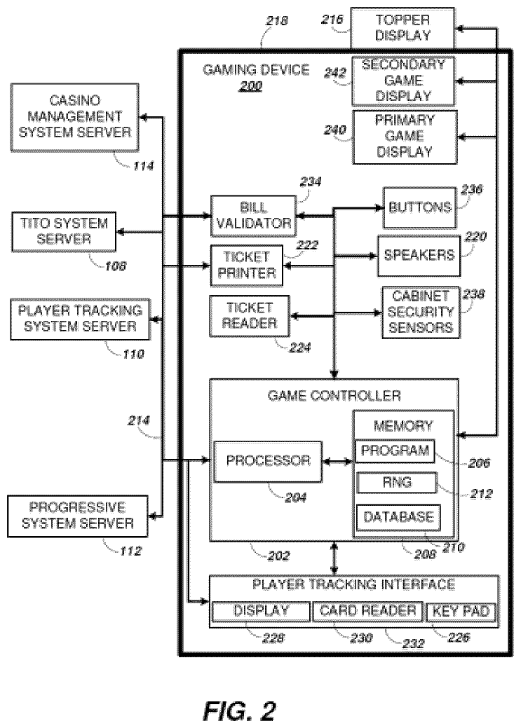

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) industry-specific requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

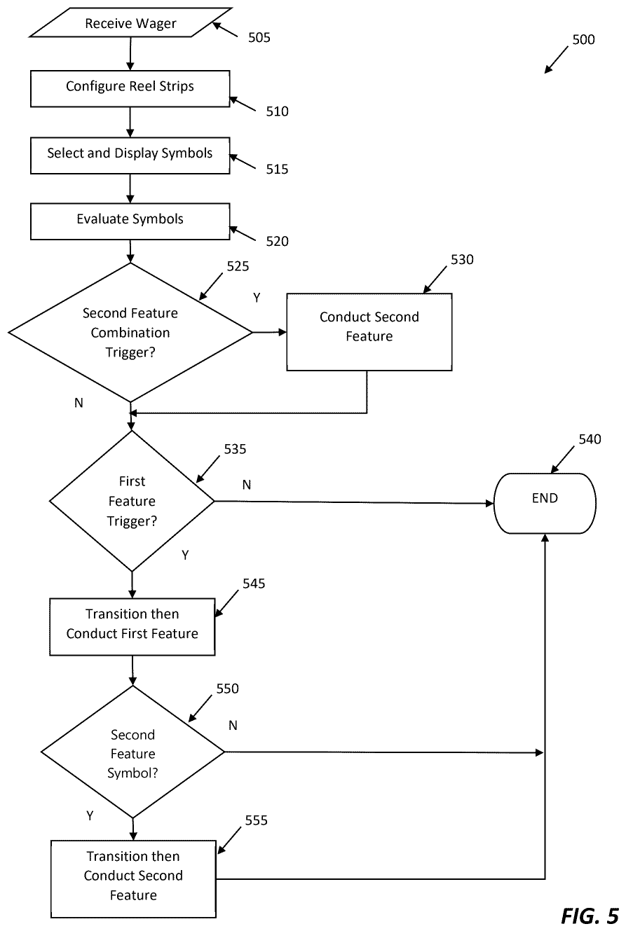

FIG. 5 is a flow chart of an example embodiment of a method 500 of operating a gaming device. At step 505, processor 204 initiates a play of a game by initiating a base game in response to receiving a wager (e.g. in response to a player making a wager selection using buttons as described above).

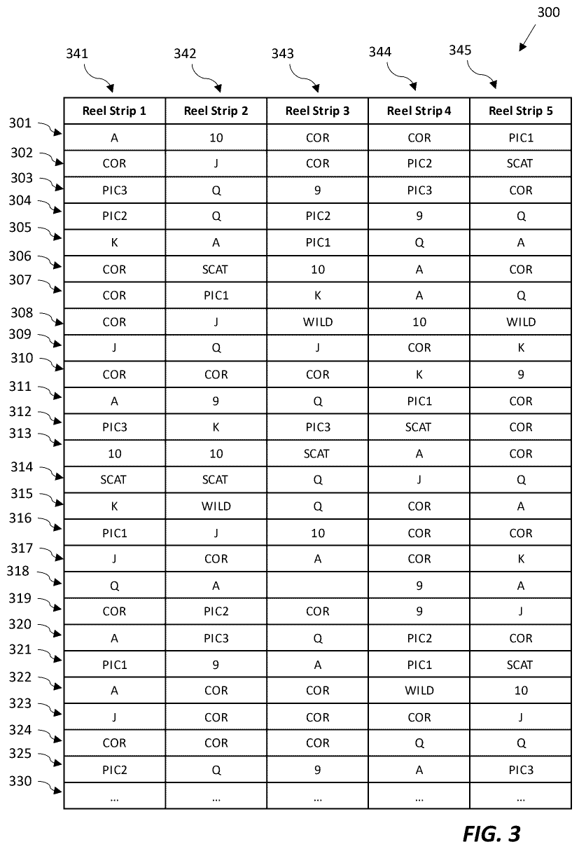

At step 510, the processor 204 configures the reel strips for a current game instance based on symbol data in memory 208. In this respect, FIG. 3 illustrates an example of a set 300 of five reel strips 341, 342, 343, 344, 345 that may be defined by symbol data. In the example, for illustrative purposes, twenty-five reel strip positions 301-325 are shown for each reel strip 341-345. Each reel strip position of each reel has a symbol or a configurable symbol position. For example, a “Wild” symbol occupies the twenty-first reel strip position 321 of the fourth reel 344. The symbols shown on the reel strip are generally indicative of symbols that may be employed in the embodiments but it will be appreciated that there visual appearance and the composition will depend on factors such as the visual theme of the game and desired return to player. That is, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the number of wild symbols (in general, the more wilds there are, the longer the reel strip needs to be), and volatility (in general, the higher the prize value is, the longer the reel strip needs to be to lower the hit rate). In some examples, the reel strips associated with different columns may be of different lengths to one another.

In the examples, the reel strips include a plurality of configurable symbol positions, here designated as “COR” (e.g. at the tenth symbol position 310 of the first and second reel strips 341,342) which is an abbreviation for “Cash on Reel” because when configured by prize symbols, many of these symbols will display winnable prize amounts in currency or credits. The COR symbol positions are configured at step 510 by processor 204 as part of each base game instance. In an example, the symbol data in memory 208 also includes a set of prize symbols defined in a weighted table and COR symbol positions are configured by processor 204 using RNG 212 to randomly select prize symbols using the weighted table. In an example, at least one, and advantageously, only one of the prize symbols in the weighted table is a second feature trigger symbol which will result in an award of a second feature game when processor 204 determines that an award criterion is met. In an example, processor 204 selects symbols without replacement so that the second feature trigger symbol can only be selected once.

In some examples, the prize values of some or all of the symbols depend on the amount wagered. In some examples, the prize values can be set based on an amount wagered. In some examples, credit prize values may a multiple of the amount wagered or a component of the wager.

In an alternative example, processor 204 randomly selects using RNG 212 and another weighted table, a COR position to be occupied by the second feature trigger symbol so that the second feature trigger symbol will always appear on the reel strips and then selects prize symbols for the remaining COR positions.

In some examples, the set of selectable prize symbols may comprise a mixture of prize symbols associated with jackpot or bonus prizes having currency values, and prize symbols having credit values. For example, a set of prize symbols may include: at least one second feature symbol; at least one major jackpot symbol, at least one super bonus symbol, at least one maxi bonus symbol, at least one minor bonus symbol, at least one bonus symbol, and credit value symbols (e.g. 500, 1000, 1500, 2500 and 5000 credits). The number of specific prize symbols may depend on an intended return to player and typically will include more lower value prize symbols than higher value prize symbols. In some examples, symbol set may include one or more mystery prize symbols which can take one of a plurality of different values. For example, one value may be a relatively large prize and other values may be smaller. A mystery prize symbol may be used, for example, to control the relative frequency of a large prize being awarded, such as a major jackpot prize. In an example, a mystery prize symbol is used instead of a major jackpot prize symbol. In an example, if the mystery prize symbol is selected, processor 204 uses a weighted table and RNG 212 to determine the value to be awarded from the mystery prize symbol.

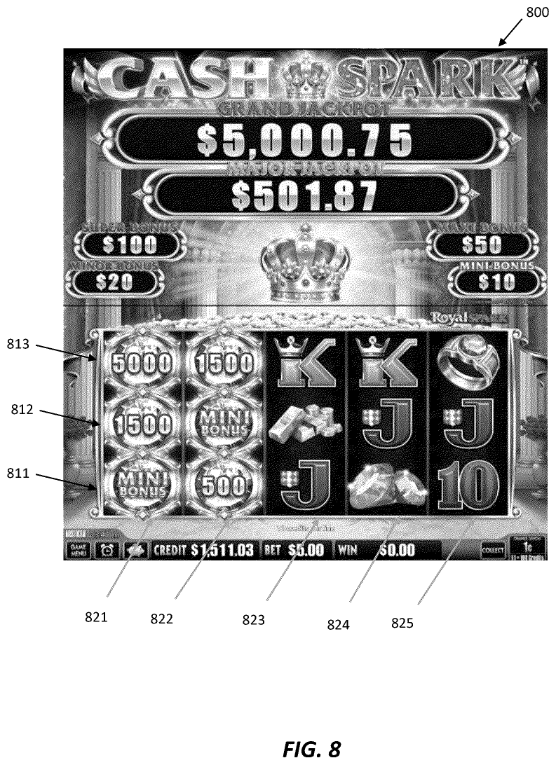

At step 515, processor 204 selects symbols for a spinning reel game using the configured reel strips and controls the display 240 to display the selected symbols. FIG. 8 shows an example screen display 800 of a base game where symbols are selected from five configured reel strips for display in five columns of symbol positions 821-825 with three symbols being selected from each reel strip such that there are also three rows 811-813 of symbol positions.

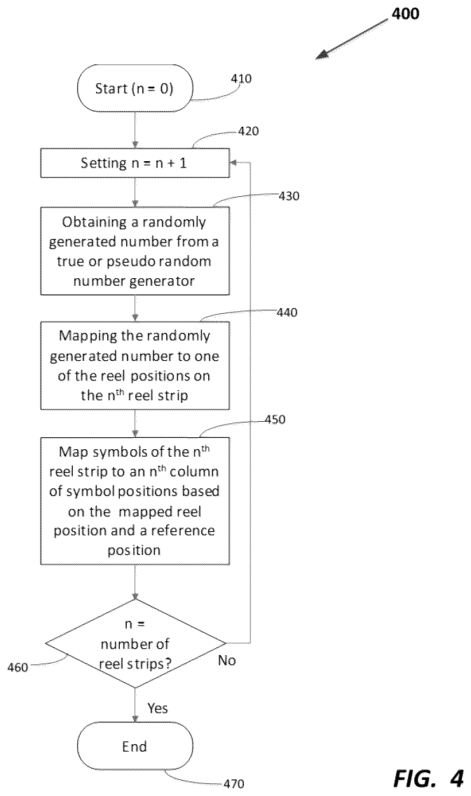

FIG. 4 is a flow chart of an example method 400 carried out by the processor 204 to select symbols at step 515 from reel strips configured at step 510. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to and nth column of symbol display positions based on the mapped reel position and a reference position. In an example, the reference position is the bottom position of the symbol positions of each column of symbol positions. In this example, the selected reel position (and hence the symbol at this position) is mapped to the bottom symbol position of the column. Referring to the example reel strips of FIG. 3, if the value returned by the RNG 212 is mapped to reel position 313 when three symbols are being selected from each reel, then for the first reel strip 341, “10” is mapped to a bottom symbol position in bottom row 811, “PIC3” symbol is mapped to a middle symbol position in middle row 812, and “A” symbol is mapped to a top symbol position in top row 813.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. Different numbers of symbols may be mapped to different numbers of symbol positions.

After the symbols of all reel strips have been mapped to symbol position, the processor 204 controls display 240 to display them at the symbol positions as shown in FIG. 8.

After the symbols are selected, at step 520, the processor 204 evaluates the selected symbols for one or more winning combinations based on a pay table stored in memory 208. In this example, processor 204 applies a “pay line” type evaluation by processing the selected symbols to identify instances of the same symbol appearing one defined pay lines comprising one symbol from of the columns 821-825 starting with (and including) the first column. Upon there being one or more winning combinations, the processor 204 makes an award, for example, by adding credit amounts defined by the pay table and the amount wagered to a win meter or a credit meter in memory 208. In some embodiments, the number of pay lines evaluated depend on a wager selection for a current play of the game. In some embodiments, the maximum number of pay lines available may depend on the wager.

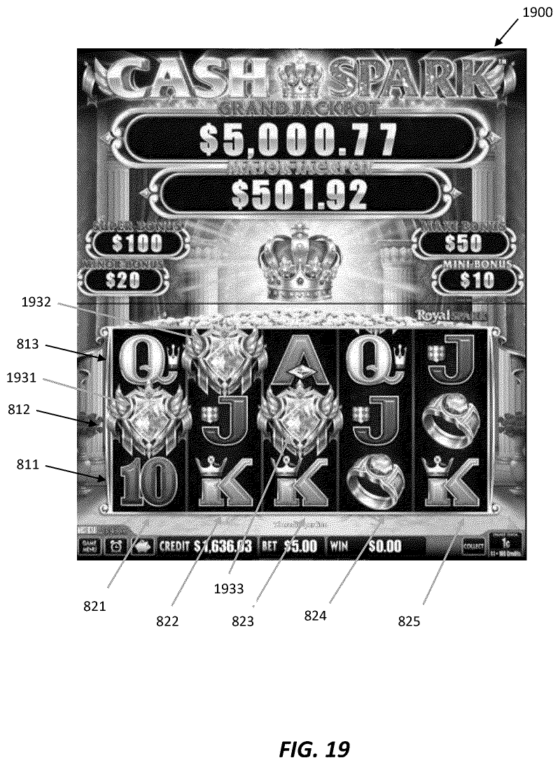

At step 525, processor 204 determines whether the selected symbols include a second feature symbol combination trigger as explained in more detail in relation to FIG. 19 below. In the case of the example, of FIG. 8, the processor 204 will make a negative determination at step 525 and proceed to step 535.

At step 535, processor 204 determines whether the selected symbols include a threshold number of prize symbols which in this context can be understood to be trigger symbols. In this example, the threshold number of trigger symbols is six. The threshold number may be different in other embodiments and may be determined based on factors such as the number of symbol positions and an intended trigger rate of the first feature game.

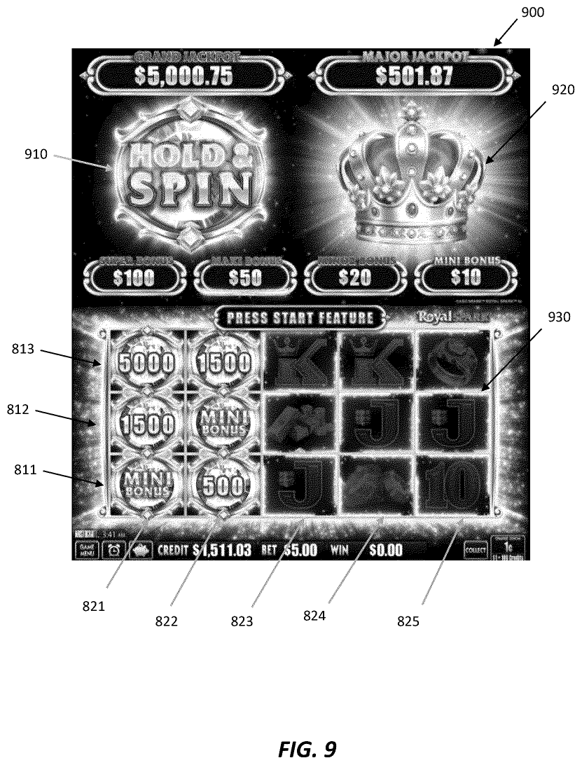

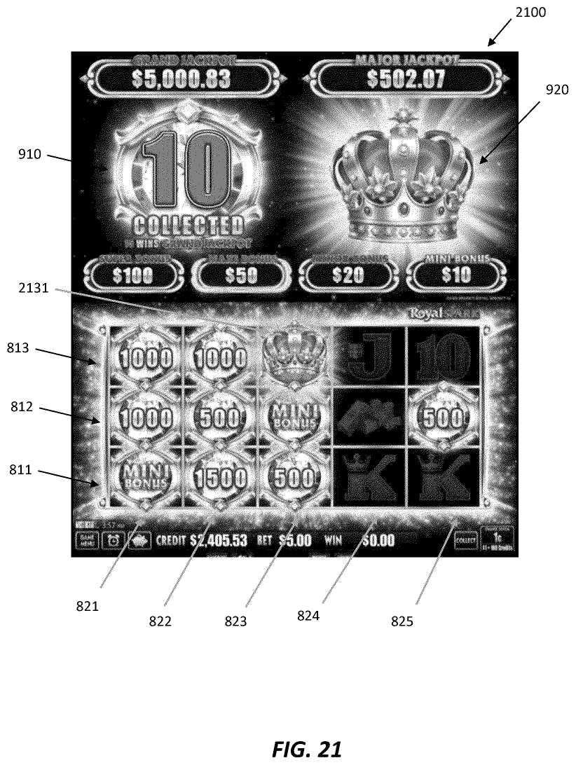

In the example, of FIG. 8, processor 204 will make a positive determination at step 535 as the selected symbols include six prize symbols. That is, in the example of FIG. 8, prize symbols have been selected at all three symbol positions of both the first and second columns 821,822. Accordingly, processor 204 will proceed to step 545 and control display 240 transition to a first feature game display 900 as shown in FIG. 9. In this example, game message 910 states “Hold & Spin” to indicate that the first feature game will be conducted and that it is a hold and spin type feature game. A crown symbol 920, which as described below corresponds visually to the second feature trigger symbol, is included in the example screen display 900 to indicate that the second feature may be awarded from the first feature game as described in relation to FIG. 21.

FIG. 9 also shows that in the first feature game, each of the triggering symbols is held in position by processor 204 from the base game (here at every symbol position of first and second columns 821,822 with processor 204 controlling display 240 to display the remaining symbols (here in the third to fifth columns 823-825) as “grayed-out”. Processor 204 also controls display 240 to add a border 930 around the individual symbol positions which visually indicates that symbols will be independently selected for individual symbol positions during the first feature game.

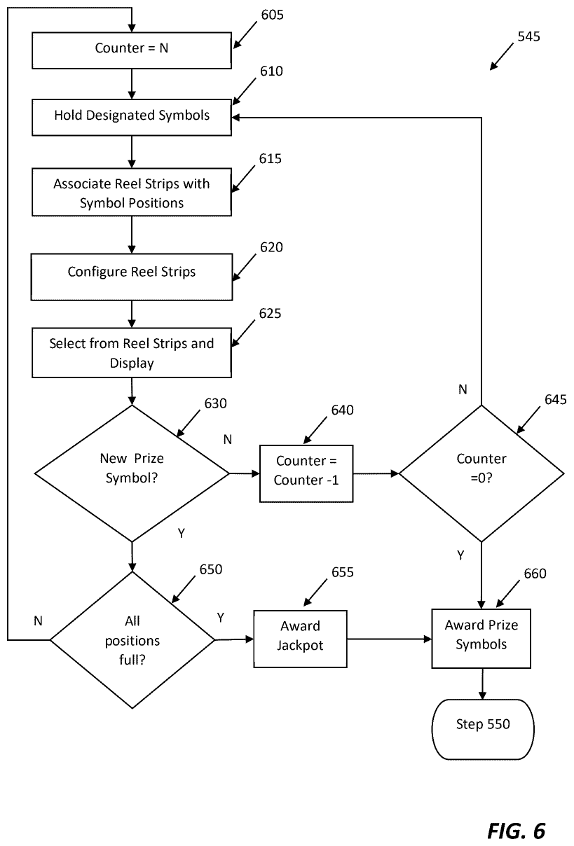

FIG. 6 shows more details of an example process implemented by processor 204 to conduct 545 the plurality of hold and spin game instances of the first feature game.

At step 605, processor 204 sets an initial counter N for the hold and spin games, in this example to three game instances as shown on hold and spin game instance counter. At step 610, the processor 204 holds prize symbols in place. In this example, prize symbols include the prize symbols from the base game instance that were part of the feature game trigger as described above and including any second feature trigger symbol. In an alternative example, the prize symbols may be held for subsequent game instances but moved to specific positions for example, so that the set of display positions is filled in a defined pattern (e.g. top to bottom, left to right).

At step 615, the processor 204 associates reel strips of a second set of reel strips stored in memory 208 with each individual symbol position that is not already occupied with a prize symbol. In an example, reel strips used by processor 204 at step 615 comprise a mixture of configurable symbol positions and “grayed-out” symbols to indicate that if they are selected, they do not count towards the outcome of the hold and spin game instances. In another example, blank symbols can be used instead of the grayed out symbols.

In an example, a first reel strip of the second set of reel strips is used to control the relative probability of all the symbol positions being filled, which in this example, results in a Jackpot being awarded at step 660. In an example, the processor 204 assigns the first reel strip to a symbol position first so that once only one symbol position remains the first reel strip will always be assigned to that symbol position. The first reel strip is typically longer than other reel strips and has very few (or only one) configurable symbol positions in order to control the probability of the Jackpot being awarded at step 660. In an example, a second reel strip of the second set of reel strips comprising the second feature trigger symbol is allocated to a second symbol position by processor 204 provided a second feature trigger symbol has not already been held at one of the display positions (either in the base game or one of the hold and spin feature games).

Processor 204 continues to randomly select symbol positions and assigns reel strips from the second set of reel strips positions until all symbol positions not occupied by a held symbol have an associated reel strip.

At step 620, processor 204 selects prize value symbols for the COR symbol positions using a weighted table. In an example, the prize values of the prize value symbols are the same as those that may be assigned by processor 204 in the base game.

At step 625, the processor 204 selects from the assigned and configured reel strips using a variant of the method described above in relation to FIG. 4. In this example, only a single position is selected from each reel strip which either will or will not have a prize symbol. In an example, processor 204 displays the outcomes of selections from the reel strips at the symbol positions on display 240 in a random order.

At step 630, the processor 204 determines whether the selection has resulted in one or more new prize symbols being selected and, upon making a positive determination proceeds to step 650.

At step 650, processor 204 determines whether all symbol positions are occupied with a prize symbol. If processor 204 makes a negative determination at step 655, processor 204 reverts to step 605 and resets the counter to N (in this example to threes) before iterating through steps 610 to 630 again.

If processor 204 makes a positive determination at step 655 that all symbol positions are occupied, processor 204 awards a Grand Jackpot prize (e.g. a largest winnable progressive jackpot prize) at step 655 before proceeding to step 660.

If at step 630, processor 204 determines the selection has not resulted in one or more new prize symbols being selected, at step 640, processor 204 decrements the counter by one. Then, at step 645, the processor 204 determines whether the counter has reached zero. In this way, if a new prize symbol is not selected in N consecutive game instances (in this example three game instances), the hold and spin game instances end and the processor 204 proceeds to step 660. When processor 204 makes a negative determination at step 645, processor 204 iterates through steps 610 to 630 again.

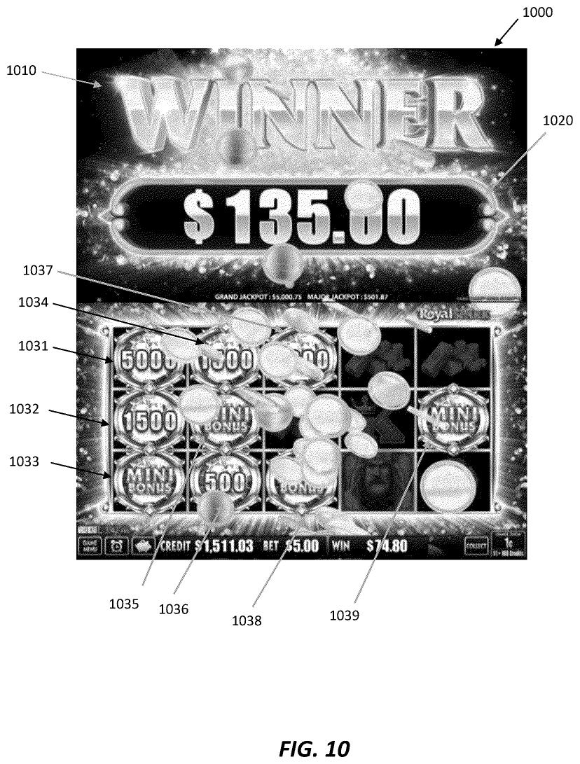

At step 560, processor 204 awards prizes corresponding to the prize symbols. FIG. 10 is an example screen display where eight prize symbols 1031-1038 are displayed at the conclusion of the feature game and processor 204 has controlled the display to display game message “Winner” and a total prize award 1020, here “$135.00”.

Processor 204 then reverts to step 550 of FIG. 5 and determines whether the prize symbols include the second feature symbol. In the example of FIG. 10, processor 204 will make a negative determination at step 550 and will end the play of the game instance at step 540. In some examples, the process 500 implemented by processor 204 may also include an opportunity for player to gamble some or all game outcomes, e.g. by making a double or nothing wager.

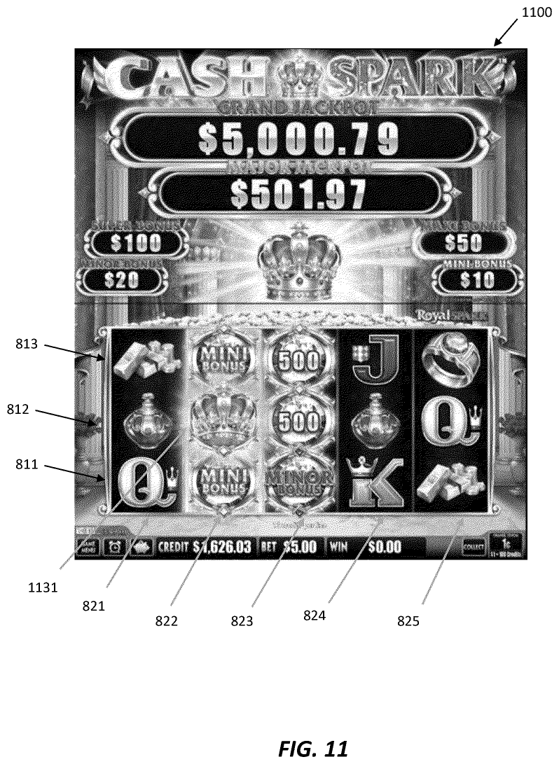

As indicated above, the second feature trigger symbol may be one of the triggering prize symbols selected by processor 204 in the base game. FIG. 11 is an example screen display 1100 where this has occurred. That is, in this example, prize symbols have been selected for all symbol position of the second and third columns 822,823 and include second feature trigger symbol 1131.

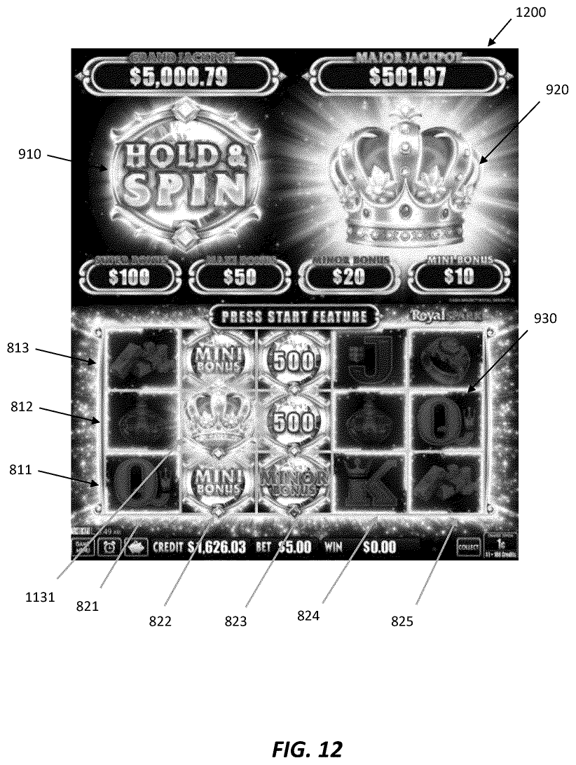

Accordingly, in this example, processor 204 will make a positive determination at step 535 because there is a threshold number of trigger symbols (here five first trigger symbols and the second feature trigger symbol 1131), proceed to step 545 and control display 240 transition to a first feature game display 1200 as shown in FIG. 12. As described above, each of the trigger symbols is held in position by processor 204 from the base game (here at every symbol position of second and third columns 822, 823 with processor 204 controlling display 240 to display the remaining symbols (here in the first, fourth and fifth columns 821,824,825) as “grayed-out”. Processor 204 also controls display 240 to add a border 930 around the individual symbol positions which visually indicates that symbols will be independently selected for individual symbol positions during the first feature game.

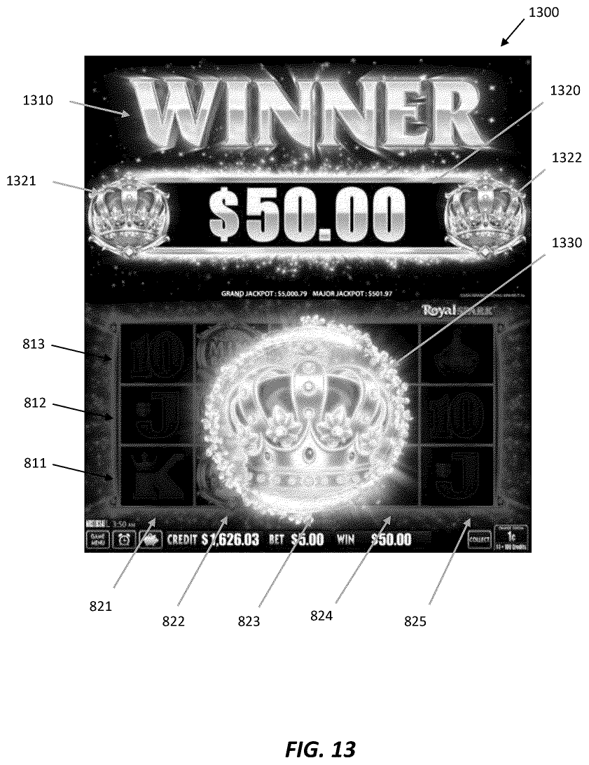

Play of the first feature game is then controlled by processor 204 in the manner described in relation to FIG. 6 above. In this case, when reverting to step 550 after conducting the first feature game instance, processor 204 will make a positive determination and proceed to step 555 and transition to a second feature game and conduct the second feature. FIG. 13, shows an example transitional screen display 1300 in which a graphic object 1330 corresponding to second feature trigger symbol is superimposed on a final outcome of the first feature game to indicate that the second feature game will be conducted. Similar to FIG. 10, processor 204 has controlled the display to display game message “Winner” 1310 and a total prize award 1320 (here “$50.00”) but processor 204 has also controlled the display 240 to display the total prize award 1320 between a further pair of graphic objects 1321, 1322 corresponding to second feature trigger symbol to indicate that the second feature game will be conducted.

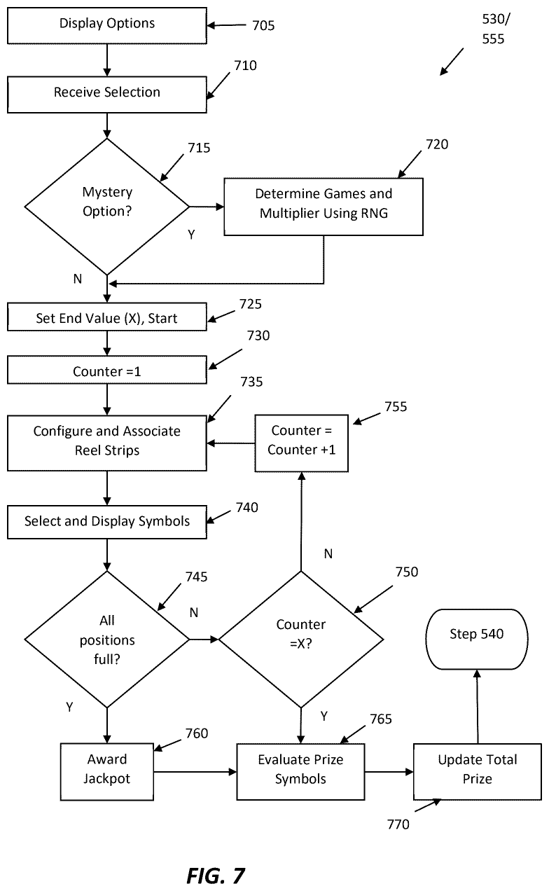

Further details of a process implemented by processor at step 530 or step 555 in order to conduct the second feature game are illustrated with respect to FIG. 7.

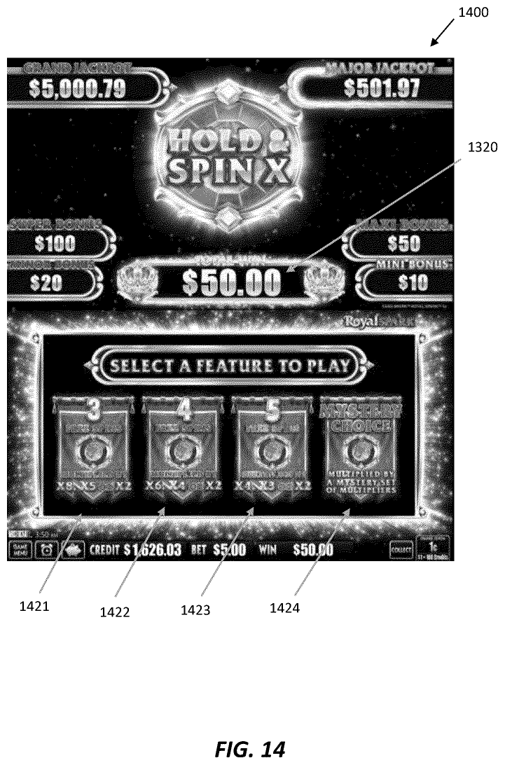

At step 705, processor 204 controls the display to display a screen display 1400 (see FIG. 14) of selectable game play options 1421-1424. In an example, three game play options 1421-1423 comprise a fixed number of game instances and a set of multipliers that can be applied to a specific class of prize symbols as explained in further detail below. In this example, first game play option 1421 comprises three game instances and the set of multipliers ×8, ×5, ×2; second game play option 1422 comprises four game instances and the set of multipliers ×6, ×4, ×2; and third game play option 1423 comprises five game instances and the set of multipliers ×4, ×3, ×2. The fourth game play option 1424 is a mystery choice option.

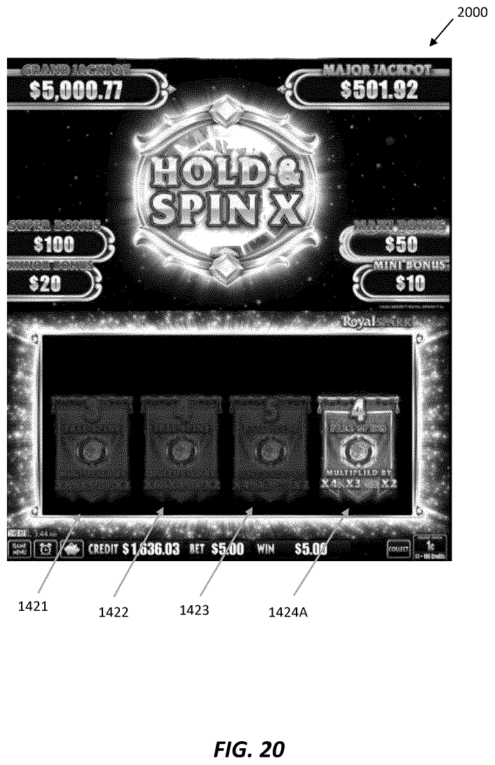

At step 710, processor 204 receives a selection. At step 715, processor 204 determines whether the selection is the mystery option 1424 and if so, at step 720 processor 204 uses RNG 212 and a weighted table to select a number of games to be conducted and a set of multipliers. An example screen display 2000 following such a random selection is shown in FIG. 20 where processor 204 has controlled the display 240 to display first to third game play options 1421-1423 as grayed-out, and to display an updated graphic 1424A corresponding fourth game play option which shows that processor 204 has selected four game instances to be conducted and a multiplier set comprising ×4, ×3 and ×2 multipliers.

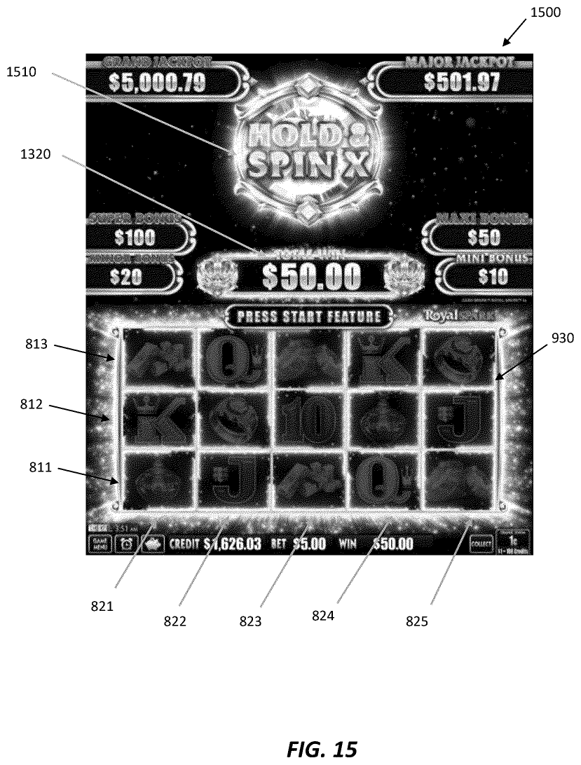

At step 720, processor 204 sets a counter end value (X) based on the number of game instances to be conducted, either as selected or randomly determined. Processor 204 then controls the display 240 to display an initial second feature screen display 1500, an example of which is shown in FIG. 15. It will be observed from FIG. 15 that one of the differences between the first and second feature games is that there are no held symbols from the first feature game (or base game) such that each of columns 821-825 is empty at the start of the second feature game. Processor 204 also controls display 240 to display game messaged “Hold & Spin X” to indicate that the second feature game is being conducted.

Once the player presses start (e.g. by pressing a play button), processor 204 initiates the second feature hold and spin feature by setting the counter to 1 at step 730. Then, at step 735, processor 204 configures a third set of reel strips having configurable reel strip positions with prize symbols and associates individual reel strips with individual symbol positions using the processes described in relation to FIG. 6. A difference between the first and second feature games is that in this example, there are two different classes of prize symbols, a first class which are the same as those described in relation to the first feature game and a second class having an associated multiplier. Depending on the implementation, a multiplier of the configured set of multipliers is assigned to each prize symbol of the second class at the time the reel strips are configured or dynamically after a symbol of the second class has been selected by processor 204 to form part of the game outcome. In either case, processor 204 can select a multiplier to be associated with a prize symbol of the second class using RNG 212 and a weighted table defining the relative probability of individual ones of the configured set of multipliers being selected. In an example implementation, the configurable reel strip positions define whether specific reel strip positions of the reel strips are to be configured with a first or second class of prize symbol. In another example, processor 204 selects prize symbols using a weighted table that includes entries for both first and second class prize symbols.

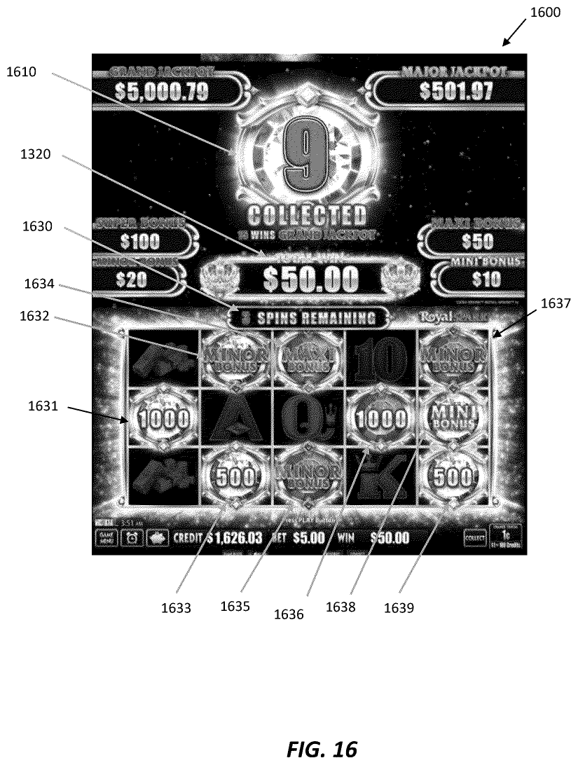

In an example, the two classes of prize symbols have a mixture of common and different visual characteristics to indicate to the player that they will contribute to game outcomes in common and different ways. For example, the shape may be common but the colour may be different as shown in the example of FIGS. 16 to 18 where the first class of symbols (i.e., 1631,1632, 1633, 1638, 1639) are predominantly white in color and the second class of symbol (i.e., 1634-1637) are predominantly red in color. It is to be understood that any desired visual characteristic distinctions may be used to delineate between the first and second class of symbols.

At step 740, processor 204 selects and displays symbols from the configured reel strips, again using the processes described above in relation to FIG. 6.

At step 745, processor 204 determines whether all symbol positions are occupied with a prize symbol. If processor 204 makes a positive determination at step 745 that all symbol positions are occupied, processor 204 awards a Grand Jackpot prize at step 760. In this way, advantageously, a same prize can be awarded from the first and second feature games by satisfying a same criterion (filling all symbol positions). It will be appreciated that in other examples, the common prize that can be awarded from first and second feature games need not be a progressive jackpot prize—e.g. it could be a fixed prize. Processor 204 then proceeds to step 765 and evaluates the prize symbols as described in further detail below.

If processor 204 makes a negative determination at step 745, processor 204 proceeds to step 750 and determines whether the counter has reached the configured end value. If not processor 204 proceeds to step 755 and increments the counter by one before beginning iterating from step 735.

FIG. 16 is an example screen display 1600 during conduct of the second feature game showing an outcome after one of the game instances has been conducted. That is, at some time after step 740 has been conducted and before the next game instance begins. As indicated by spin counter message 1630, at this stage, there are “3 Spins Remaining”. In screen display 1600, symbol collection game message 1610 indicates “9 [prize symbols] collected. 15 Wins Grand Jackpot”. In this example, the nine prize symbols 1631-1639 that have been selected include five symbols of the first class of prize symbols 1631,1632, 1633, 1638, 1639, and four symbols of the second class of prize symbols 1634-1637. It will be observed that at this stage, no multipliers are shown in association with the second class of prize symbols.

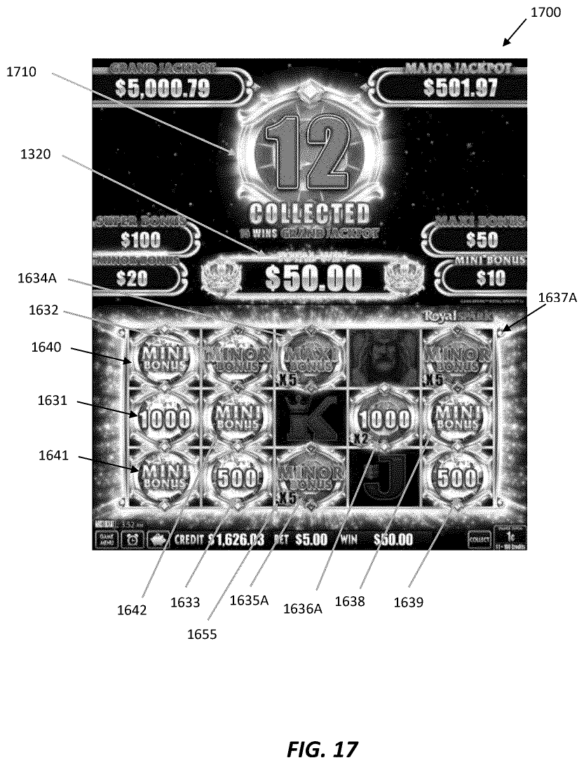

FIG. 17 is an example of a subsequent screen display 1700, where all the game instances of second feature game have been conducted. Accordingly, at step 750 processor 204 will make a positive determination and proceed to step 765 and evaluate the prize symbols. As indicated above, in an example, evaluation of the prize symbols includes processor 204 determining a value of the multiplier to be associated with each selected prize symbol of the second class by selecting a multiplier from the configured set of multipliers using RNG 212. As described above, in other examples, processor 204 reveals a previously determined multiplier.

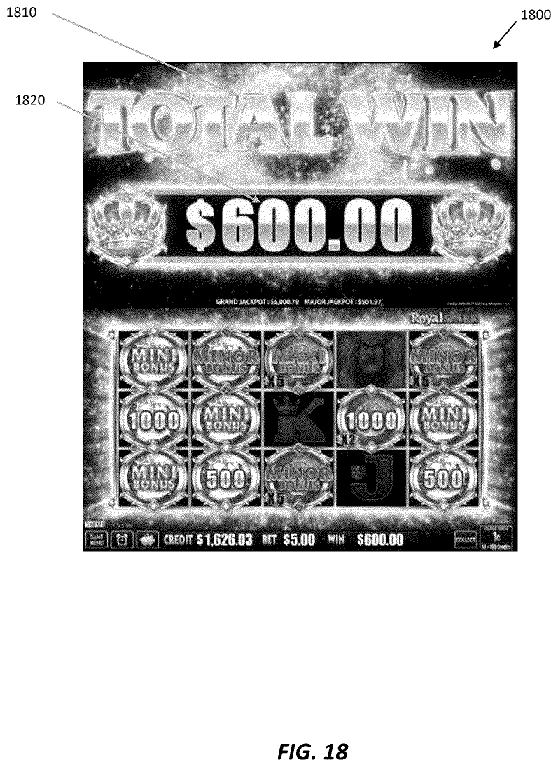

In screen display 1700 of FIG. 17, updated symbol collection message 1710 indicates “12 [prize symbols] collected. 15 Wins Grand Jackpot”. It will be observed that three additional prize symbols 1640-1642 have been selected which are all of the first class. It will also be observed that processor 204 has controlled display 240 to show updated second class of prize symbol graphics 1634A, 1635A, 1636A, 1637A to include a multiplier at a bottom lefthand corner. For example, updated prize symbol graphic 1635A now incorporates a ×5 multiplier 1655. Processor 204 evaluates the prizes based on the prizes shown on the prize symbols and the relevant multipliers. Then, at step 770, processor updates the total prize won based on the amount won in the first feature game (in this example $50) and the amount won in the second feature game (in this example, $550) and controls the display to display the display screen 1800 shown in FIG. 18 which has a “Total Win” game message 1810 and a total win amount message 1820 which, in this example is $600. After the total win amount has been displayed, the processor 204 proceeds to step 540 and ends the game.

As described above, at step 525, processor 204 determines whether the selected symbols include a second feature combination trigger. In an example, the second feature trigger combination is that at least three scatter symbols (shown as SCAT in reel strips 341-345) are selected at any symbol position in the base game. FIG. 19 is an example screen display 1900 where processor 204 has selected three scatter symbols 1931-1933 at step 515. Accordingly, at step 525, processor 204 will conduct the second feature using the process described in relation to FIG. 7 above.

As described above, where second feature trigger symbol is not part of the first feature game trigger, the configuration process of the reel strips performed by the processor 204 during the first feature game is such that the second feature symbol may be selected during the first feature game. FIG. 21 is an example screen display during the first feature game, where the second feature symbol has been selected. Accordingly in this example, after step 545 processor 204 will make a positive determination at step 550 and proceed to step 555 and conduct the second feature game.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A gaming device comprising:
an electronic display;
a random number generator;
a processor; and
memory storing (i) symbol data defining a first set of reel strips, and trigger symbols including a plurality of first trigger symbols and at least one second trigger symbol, and (ii) instructions which when executed by the processor, cause the processor to:
control the display to display a plurality of columns of symbol positions for which symbols will be selected in at least a base game;
select from the first set of reel strips, using the random number generator, symbols for each of the symbol positions;
upon the selected symbols including at least a defined number of trigger symbols, award a first feature game;
upon the at least a defined number of trigger symbols including the second trigger symbol, additionally award a second feature game; and
conduct each awarded feature game.

2. The gaming device as claimed in claim 1, where when the instructions are executed by the processor, they cause the processor to conduct the second feature game after the first feature game.

3. The gaming device as claimed in claim 1, wherein the first feature game is a hold and spin feature game, the symbol data comprises a second set of reel strips, and when the instructions are executed by the processor, they cause the processor to:
hold each trigger symbol selected in the base game for the hold and spin game;
conduct game instances of the first feature game until an end condition is met; and
conduct each game instance of the hold and spin game by selecting a symbol for each symbol position not occupied by a held symbol from the second set of reel strips, and holding each selected symbol meeting a hold criterion for any subsequent game instance.

4. The gaming device as claimed in claim 3, wherein each first trigger symbol is a prize symbol, and a hold criterion is that a selected symbol is a prize symbol, and wherein when the instructions are executed by the processor, they cause the processor to make an award based on the prize symbols displayed at the conclusion of the first feature game.

5. The gaming device as claimed in claim 3, wherein upon the second feature game not being awarded during the base game, when the instructions are executed by the processor, they:
cause the processor to configure the second set of second reel strips to enable the second trigger symbol to be selected during the first feature game; and
upon the second trigger symbol being selected during the first feature game, award the second feature game.

6. The gaming device as claimed in claim 1, wherein the second feature game comprises another hold and spin feature game wherein no symbols are held from the base game or the first feature game, the symbol data comprises a third set of reel strips and wherein when the instructions are executed by the processor, they cause the processor to:
conduct a configured number of game instances; and
conduct each game instance of the hold and spin game by selecting a symbol for each symbol position not occupied by a held symbol from the third set of reel strips, and holding each selected symbol meeting a hold criterion for any subsequent game instance.

7. The gaming device as claimed in 6, wherein when the instructions are executed by the processor, they cause the processor to present a plurality of second feature game options on the display prior to conducting the second feature game and, responsive to selection of one of the displayed options, configure the number of game instances and a set of multipliers.

8. The gaming device as claimed in claim 7, wherein one of the plurality second feature game options comprises conducting a random determination, and in response to selection of the random determination option, the instructions cause the processor to use the random number generator to configure the number of game instances by selecting the number from a plurality of different numbers of game instances and selecting a set of multipliers of a plurality of different sets of multipliers.

9. The gaming device as claimed in claim 7, wherein the third set of reel strips comprises a first class of prize symbol and a second class of prize symbols, and wherein the hold criterion is that a prize symbol is selected, and wherein, when the instructions are executed by the processor, they cause the processor to select, using the random number generator, a multiplier from the set of multiplier, for at least each selected prize symbol of the second class.

10. The gaming device as claimed in claim 1, wherein the first and second feature games are each hold and spin games, and wherein when the instructions are executed by the processor, they cause the processor to make a same award upon all of the symbol positions being occupied by prize symbols, during, or at the conclusion of at least one of the first and second feature game.

11. The gaming device as claimed in claim 1, wherein, when the instructions are executed by the processor, they cause the processor to award the second feature game independently of the first feature game in response to a defined combination of symbols being selected in the base game.

12. The gaming device as claimed in claim 2, wherein, when the instructions are executed, they cause the processor to control the display to display a total win meter having a value for the first feature game derived from award amounts in the first feature game, and having an updated value at the conclusion of the second feature game derived from award amounts in the first feature game and second feature game.

13. A method of operating a gaming device comprising an electronic display, a random number generator, and a memory storing symbol data defining a first set of reel strips and trigger symbols including a plurality of first trigger symbols and at least one second trigger symbol, the method comprising:
controlling the display to display a plurality of columns of symbol positions for which symbols will be selected in at least a base game;
selecting from the first set of reel strips, using the random number generator, symbols for each of the symbol positions;
upon the selected symbols including at least a defined number of trigger symbols, awarding a first feature game;
upon the at least a defined number of trigger symbols including the second trigger symbol, additionally awarding a second feature game; and
conducting each awarded feature game.

14. The method as claimed in claim 13, comprising conducting the second feature game after the first feature game.

15. The method as claimed in claim 13, wherein the first feature game is a hold and spin feature game, the symbol data comprises a second set of reel strips, and the method comprises:
holding each trigger symbol selected in the base game for the hold and spin game;
conducting game instances of the first feature game until an end condition is met; and
conducting each game instance of the hold and spin game by selecting a symbol for each symbol position not occupied by a held symbol from the second set of reel strips, and holding each selected symbol meeting a hold criterion for any subsequent game instance.

16. The method as claimed in claim 15, wherein each first trigger symbol is a prize symbol, and a hold criterion is that a selected symbol is a prize symbol, and the method comprises making an award based on the prize symbols displayed at the conclusion of the first feature game.

17. The method as claimed in claim 13, wherein the first and second feature games are each hold and spin games, and wherein when the instructions are executed by the processor, they cause the processor to make a same award upon all of the symbol positions being occupied by prize symbols, during, or at the conclusion of at least one of the first and second feature game.

18. The method as claimed in claim 13, comprising awarding the second feature game independently of the first feature game in response to a defined combination of symbols being selected in the base game.

19. The method as claimed in claim 14, comprising controlling the display to display a total win meter having a value for the first feature game derived from award amounts in the first feature game, and having an updated value at the conclusion of the second feature game derived from award amounts in the first feature game and second feature game.

20. A system comprising:
at least one display;
a random number generator;
one or more processors; and
at least one memory storing (i) symbol data defining a first set of reel strips, and trigger symbols including a plurality of first trigger symbols and at least one second trigger symbol, and (ii) instructions which, when executed by the one or more processors, cause the one or more processors to:
control the at least one display to display a plurality of columns of symbol positions for which symbols will be selected in at least a base game;
select from the first set of reel strips, using the random number generator, symbols for each of the symbol positions;
upon the selected symbols including at least a defined number of trigger symbols, award a first feature game;
upon the at least a defined number of trigger symbols including the second trigger symbol, additionally award a second feature game; and
conduct each awarded feature game.
